(19) United States
(12) Patent Application Publication
(10) Pub. No.: US 2016/0055756 A1
(43) Pub. Date: Feb. 25, 2016

(54) Methods and Software for Motivating a User to Partake in an Activity Using an Electronic Motivational Learning Tool and Visual Motivational Stimulus

(71) Applicant: FLASHLABS LLC, New York, NY (US)

(72) Inventors: Michael De Guzman, New York, NY (US); Kathleen De Guzman, New York, NY (US); Cristina De Guzman, Brighton, MA (US)

(21) Appl. No.: 14/781,196

(22) PCT Filed: Mar. 28, 2014
(86) PCT No.: PCT/US14/32185

§ 371 Date: Sep. 29, 2015

Related U.S. Application Data
(60) Provisional application No. 61/806,679, filed on Mar. 29, 2013.
(60) Provisional application No. 61/892,207, filed on Oct. 17, 2013.

(51) Int. Cl. G09B 7/00; G09B 7/04; G09B 7/08; G09B 19/02

(52) U.S. Cl. CPC G09B 7/00; G09B 19/025; G09B 7/04; G09B 7/08

(57) ABSTRACT

Methods and software that motivate one or more users to partake in an activity using an electronic motivational learning tool. This functionality can allow students to remain motivated to study even when the subject matter is dry, such as in the case of rote memorization of vocabulary or mathematical concepts. Various corresponding and related methods and software are described.

This application claims the benefit of priority of U.S. Provisional Patent Application Ser. No. 61/806,679, filed on Mar. 29, 2013, and titled “Swimsuit Motivation Learning Technology,” and of U.S. Provisional Patent Application Ser. No. 61/892,207, filed on Oct. 17, 2013, and titled “Media-Based Motivational Learning Software Tool,” each of which is incorporated herein by reference in its entirety.

### FIELD OF THE INVENTION

The present invention generally relates to the field of educational technology. In particular, the present invention is directed to methods and software for motivating a user to partake in an activity using an electronic motivational learning tool and visual motivational stimulus.

### BACKGROUND

Various products for assisting students with learning are presently available. For example, physical and computerized flash cards and learning games have long been used as means for learning or memorizing aspects of many different subjects, such as definitions of words, mathematical concepts like addition and multiplication, chemical formulas, and others. However, in using such products, students must sacrifice time that could be spent pursuing more entertaining activities. As a result, many students find difficulty in maintaining the motivation to study.

### SUMMARY OF THE DISCLOSURE

In one implementation, the present disclosure is directed to a method of motivating a user to partake in an activity. The method being executed automatedly in an electronic motivational learning tool includes presenting to the user responsorial matter and a visual motivational stimulus; receiving from the user a response to the responsorial matter; determining a correctness of the response; and controlling a level of obscurity of the visual motivational stimulus as a function of the correctness of the response.

In another implementation, the present disclosure is directed to a method of motivating a user to partake in an activity. The method being executed automatedly in an electronic motivational learning tool includes presenting to the user first responsorial matter and a first visual motivational stimulus; receiving from the user a first response to the first responsorial matter; determining a first correctness of the first response; and if the first correctness is right, presenting to the user: second responsorial matter different from the first responsorial matter; and a second visual motivational stimulus different from the first.

In still another implementation, the present disclosure is directed to a machine-readable storage medium containing machine-executable instructions for performing a method of motivating a user to partake in an activity. The machine-executable instructions include a first set of machine-executable instructions for presenting to the user responsorial matter and a visual motivational stimulus; a second set of machine-executable instructions for receiving from the user a response to the responsorial matter; a third set of machine-executable instructions for determining a correctness of the response; and a fourth set of machine-executable instructions for controlling a level of obscurity of the visual motivational stimulus as a function of the correctness of the response.

In yet another implementation, the present disclosure is directed to a machine-readable storage medium containing machine-executable instructions for performing a method of motivating a user to partake in an activity. The machine-executable instructions include a first set of machine-executable instructions for presenting to the user first responsorial matter and a first visual motivational stimulus; a second set of machine-executable instructions for receiving from the user a first response to the first responsorial matter; a third set of machine-executable instructions for determining a first correctness of the first response; and a fourth set of machine-executable instructions for, if the first correctness is right, presenting to the user: second responsorial matter different from the first responsorial matter; and a second visual motivational stimulus different from the first.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating an exemplary method of motivating a user to partake in an activity;

FIG. 2A is an exemplary series of screenshots illustrating aspects of a correct response sequence in a user interface that may be used to facilitate an embodiment of the method of FIG. 1;

FIG. 2B is an exemplary series of screenshots illustrating aspects of an alternative correct response sequence in a user interface that may be used to facilitate an embodiment of the method of FIG. 1;

FIG. 2C is an exemplary series of screenshots illustrating aspects of an incorrect response sequence in a user interface that may be used to facilitate an embodiment of the method of FIG. 1;

FIG. 2D is an exemplary series of screenshots illustrating aspects of another alternative correct response sequence in a user interface that may be used to facilitate an embodiment of the method of FIG. 1;

FIG. 2E is an exemplary series of screenshots illustrating aspects of yet another alternative correct response sequence in a user interface that may be used to facilitate an embodiment of the method of FIG. 1;

FIG. 3 is an exemplary series of screenshots illustrating aspects of an incorrect response sequence in a user interface that may be used to facilitate an alternative embodiment of the invention; and

FIG. 4 is a block diagram of a computing system that can be used to implement any one or more of the methodologies disclosed herein and any one or more portions thereof.

### DETAILED DESCRIPTION

Aspects of the present invention include methods and software for motivating a user to partake in an activity using an electronic motivational learning tool. Examples of such activities include studying vocabulary, grammar, mathematical concepts, and scientific concepts and/or learning foreign languages and musical concepts, among a virtually limitless list of others. Fundamentally, there is no limitation on the types of activities in which users may be motived to partake in accordance with the present invention. In some embodiments, methods and software of the present disclosure encourage students to remain motivated to study, even when the subject matter in question is not particularly exciting, by presenting a visual motivational stimulus with responsorial matter and controlling a level of obscurity of the visual motivational stimulus as a function of the correctness of a user response to the responsorial matter. Generally, the visual motivational stimulus presented is visual stimulus that is motivating to the particular user at interest. Examples of visual motivational stimuli include, but are not limited to, photographs/videos of attractive models, appetizing foods, exciting activities, and interesting places, among others. As used herein and in the appended claims, “responsorial matter” means content of any sort that is presented for prompting a response from the user. Examples of responsorial matter include, but are not limited to, a question, a word problem, a mathematical problem, or a word or phrase of a foreign language to be pronounced, among others.

In order to provide such functionality, the methods and software disclosed herein may be implemented in an electronic motivational learning tool accessible by one or more students or other users, such as a smartphone, tablet, or other computing device. Users may access such a learning tool directly via, for example, an Internet browser or dedicated software application or indirectly through a third-party program or website or other system. As will become apparent from reading this entire disclosure, the term “electronic motivational learning tool” and like terms are used herein merely as a convenient way to refer to hardware that is controlled by suitable software to provide the underlying motivational learning functionality described herein, regardless of the form of the hardware.

In some embodiments, motivation to study is established by the motivational learning tool obscuring the visual motivational stimulus and only presenting a completely unobscured version of the stimulus when the user provides a correct response to responsorial matter. After the motivational learning tool has received a correct response from the user, it may present a new obscured visual motivational stimulus to the user along with new responsorial matter. If the user does not provide a correct response to a particular responsorial matter, the motivational learning tool may not change the level of obscuring or may increase the level of obscuring and the user may be presented with a correct answer or a clue and an opportunity to provide a new response after having seen the correct answer or clue. This functionality can motivate students to put more effort into studying than they might otherwise by offsetting the rigors of studying with visual motivational stimuli that are of interest to the student.

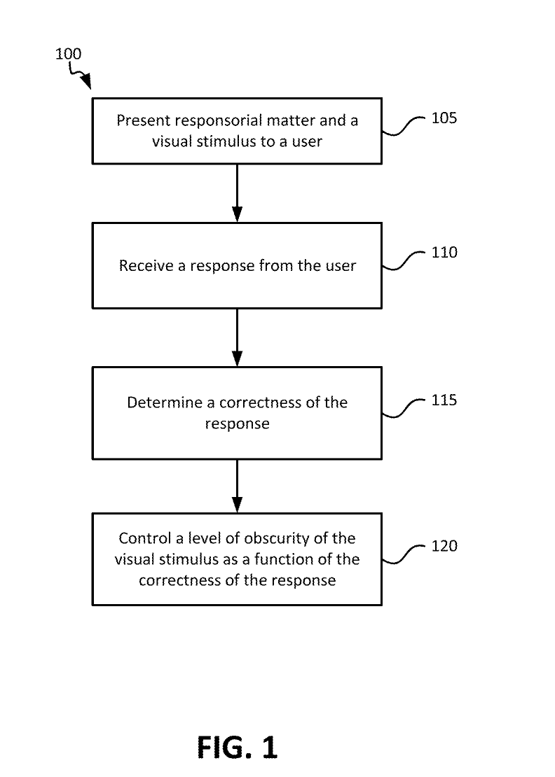

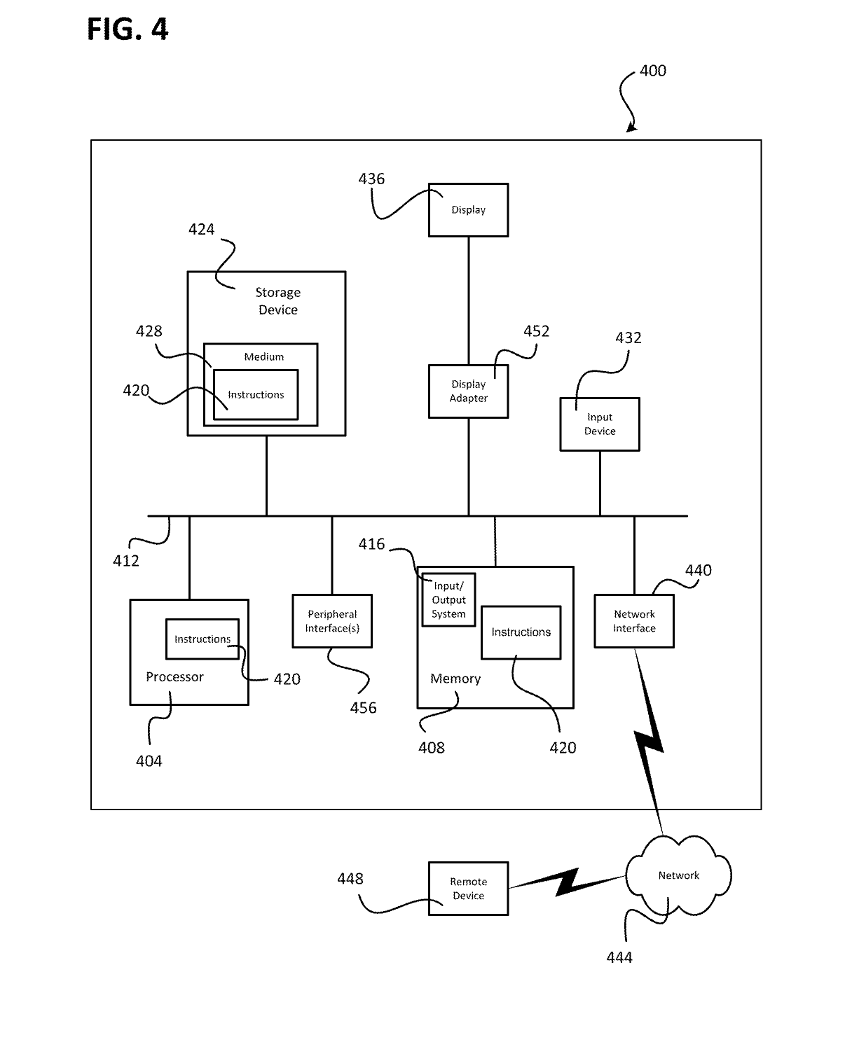

Turning now to the drawings, FIG. 1 illustrates an exemplary method 100 of motivating a user to partake in an activity using an electronic motivational learning tool and in which visual motivational stimuli are presented in varying degrees of obscureness. Method 100 may be implemented in a computing system, such as computing system 400 of FIG. 4 or a network of such or similar computing systems (e.g., a wide-area network, a global network (such as the Internet), and/or a local area network, among others), that is generally: 1) programmed with instructions for performing steps of a method of the present disclosure; 2) capable of receiving and/or storing data necessary to execute such steps; and 3) capable of providing any user interface that may be needed for a user to interact with the learning tool, including setting the tool up for a learning session and providing responses to responsorial matters, among other things. Those skilled in the art will readily appreciate that aspects of the present disclosure can be implemented with and/or within any one or more of numerous devices, ranging from self-contained devices, such as a smartphone, tablet, computer, laptop computer, desktop computer, wearable computer, server, or web-server, to a network of two or more of any of these devices. Fundamentally, there is no limitation on the physical construct of the electronic motivational learning tool, as long as it can provide one or more of the features and functionality described herein. FIG. 4, described more fully below, illustrates an exemplary computing system 400 that can be used to implement various steps of method 100 and/or any other method incorporating features/functionality disclosed herein.

Method 100 may begin at step 105, at which an electronic motivational learning tool presents responsorial matter and a visual motivational stimulus to a user via, for example, a user interface or one or more general displays. As noted above, such a visual motivational stimulus may be a photograph or video of an attractive model (such as a model posing in a swimsuit or other sexually attractive attire and/or in a sexually provocative pose (see, for example, the images appearing in U.S. Provisional Patent Application Ser. No. 61/892,207, filed on Oct. 17, 2013, and titled “Media-Based Motivational Learning Software Tool,” which has been incorporated herein by reference above), an appetizing food (such as a milkshake), a cute animal (such as a kitten or puppy), an exciting activity (such as skiing, surfing, or parasailing), or an interesting place (such as the Pyramids of Giza or the Las Vegas Strip), among others, while such responsorial matter may be a question, problem, a task, a mathematical problem, or a word or phrase of a foreign language to be pronounced, among others. In some embodiments, the visual motivational stimulus may comprise an image of a person considered to be attractive by a large group of people or an image of a person known to be attractive to a particular user, which the tool may determine, for example, by interfacing with social networking services or other external systems containing information regarding and/or provided by the user. The present inventors recognized that the appeal of any particular image or any type of image is subjective to the viewer and user of methods and software of the present invention. Consequently, the use of “attractive,” “unattractive,” and like terms herein relative to images of humans is not intended to be pejorative in any way, but merely a recognition that tastes vary from person to person and to distinguish between positive motivational feedback and negative motivational feedback as perceived by a particular user.

In an exemplary embodiment, swimsuit models may be used as the visual motivational stimuli, as these can retain user interest without being so revealing that a user would be likely to get sidetracked from studying by the images. The learning tool may select visual motivational stimuli based on a specific demographic or user-base, research that determines which kinds of stimuli retain users' interest (which may be based on, e.g., user feedback or performance statistics, such as an average amount of time a user spends per study session), and/or by any other means suitable for selecting such stimuli, including subjective assessment of images. Using this functionality, an administrator of electronic motivational learning tools used by a particular group may choose images for use as visual motivational stimuli based on their subjective impression of what might motivate their users; for example, an automobile technician trainer may choose pictures of cars they believe to be more- or less-desirable by their students for use as visual motivational stimuli.

At step 110, motivational learning tool receives a response to the responsorial matter from the user. Such a response may comprise any response that a user can provide and the learning tool can detect, such as a haptic response, a selection made with a pointing device or finger and/or a cursor, etc., and/or an oral response detected through a microphone, among numerous others that will become readily apparent to those of ordinary skill in the art after reading this disclosure in its entirety. Although embodiments may accept oral answers or pointing device selections as responses, haptic responses can be particularly useful for providing musical tempo responses to responsorial matters requesting such or for providing numerical responses to mathematical problems, among others.

After the motivational learning tool receives a response from the user, method 100 may proceed to step 115, at which the learning tool determines a correctness of the user's response. The electronic motivational learning tool may execute such a correctness determination in any appropriate fashion, such as by comparing the user's response to a set of correct or expected responses corresponding to a set of responsorial data and stored in memory or by analyzing the user's response using appropriate algorithms, such as one or more speech recognition algorithms or other mathematical or logical algorithms, among others. In some implementations, such as where responses can be partially correct, as may be the case with foreign language word pronunciations and some mathematical problems, among others, such a correctness determination may produce a confidence factor rather than a simple “right” or “wrong.” For example, if a user correctly pronounces most of a foreign language word but accents the wrong syllable or if a user provides a numerical response to a mathematical problem that is off by less than a predefined percentage or amount or is negative when it should be positive, such a determination may produce a confidence factor such as “9/10”, ”0.9”, or “90%,” indicating a computed correctness percentage or other measure of the response.

At step 120, the learning tool controls a level of obscurity of the visual motivational stimulus as a function of the correctness of the response. For example, if the learning tool determines a user's response to be correct, which in the case that a confidence factor is produced at step 115 may only require that the confidence factor is above a certain threshold, the tool may increase perceptibility of the visual motivational stimulus, while an incorrect response or confidence below such a threshold may cause the tool to decrease perceptibility of the visual motivational stimulus. Levels of obscurity and perceptibility can be effected in any of a variety of ways, including: blurring; pixelating; changing any one or more of the brightness, color, sharpness, contrast, etc.; splitting the visual motivational stimulus into tiles and scrambling or descrambling the tiles; simply “covering” or “uncovering” one or more portions of the image, such as with an interface component containing the responsorial matter; and/or increasing or reducing a resolution, overall size, or zoom level of a the visual motivational stimulus, among myriad other well-known effects and manipulations known in the art and suitable for controlling perceptibility or obscurity of an image or video. It is noted that steps 105, 110, 115, and 120 are only the steps needed to illustrate certain aspects of the invention and that other steps, such as steps of retrieving and storing information, may be utilized in conjunction with performing the steps illustrated as needed for embodying a particular implementation.

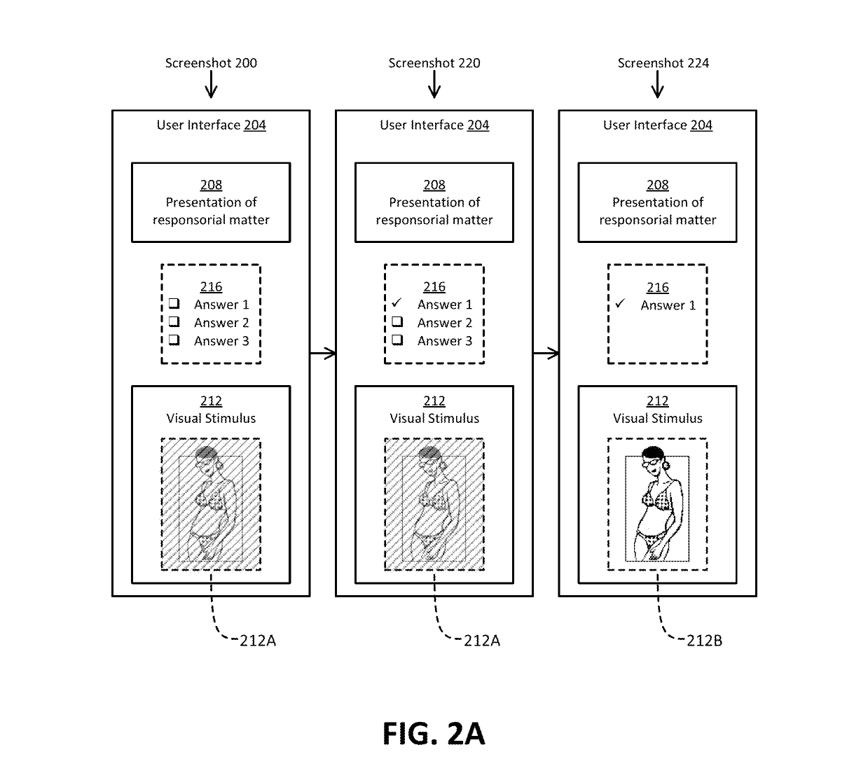

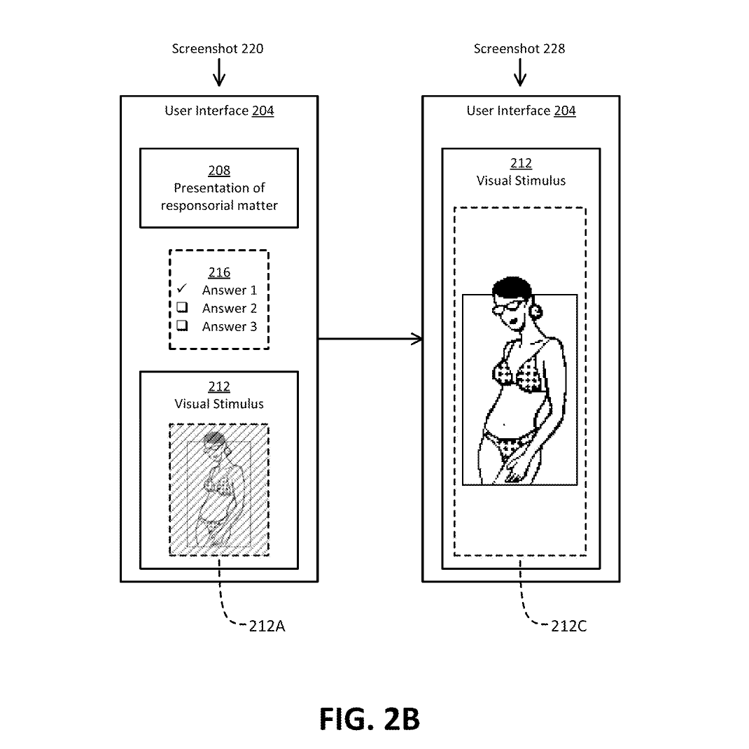

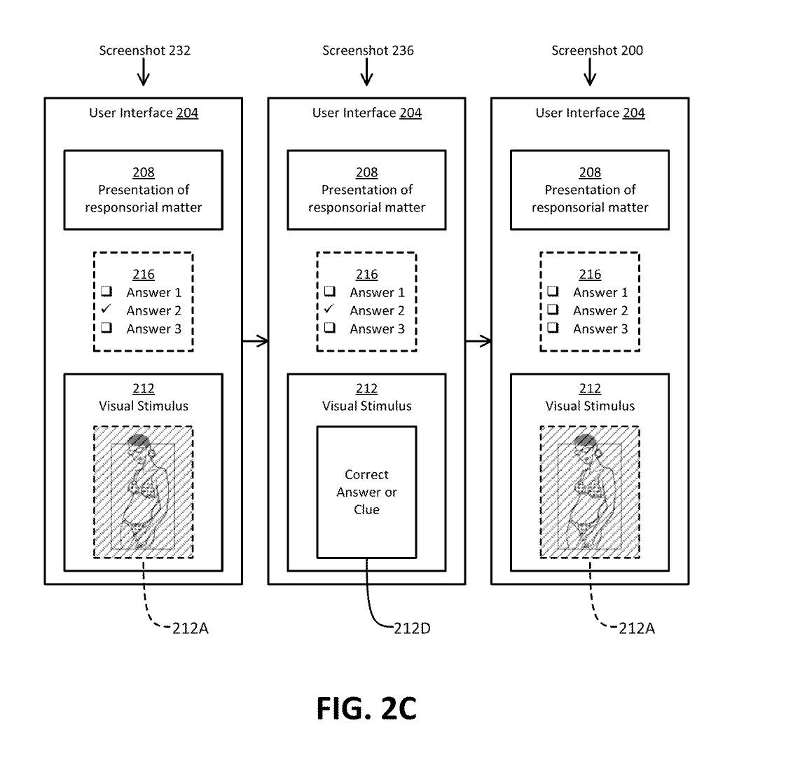

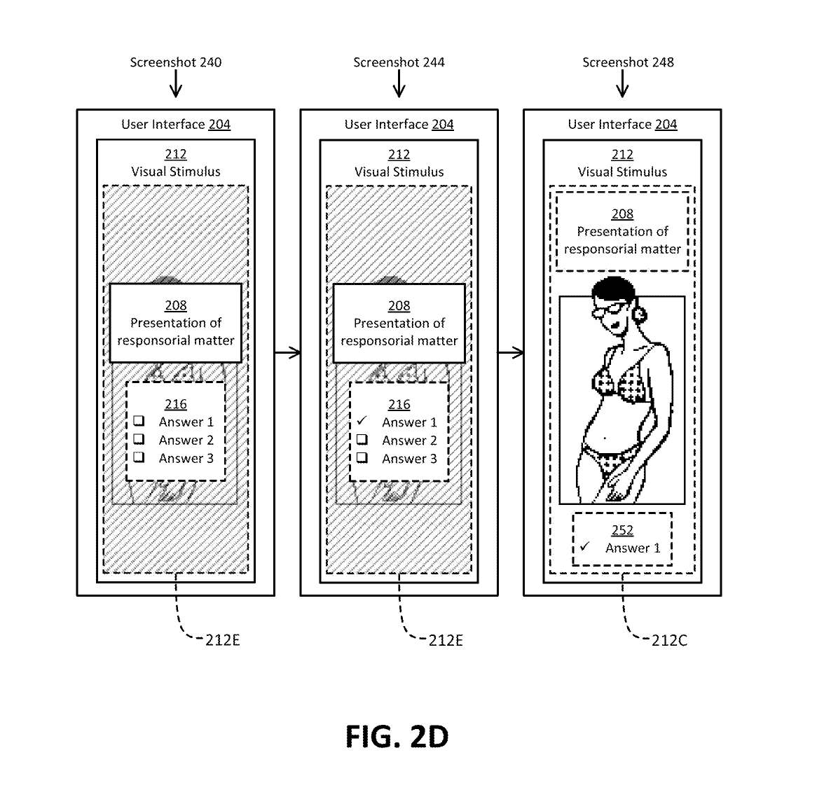

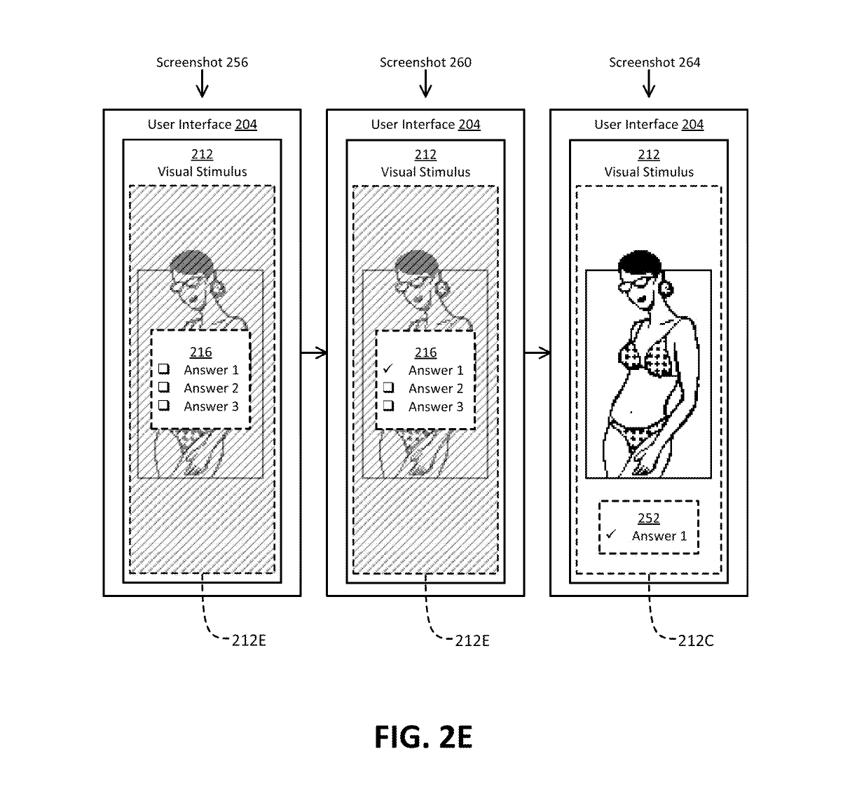

In order to illustrate a few of the numerous different ways in which a learning tool may implement aspects of method 100, FIGS. 2A-2E illustrate representative screenshot sequences of exemplary user interfaces of corresponding respective electronic motivational learning tools (not shown) that may be used to facilitate an embodiment of the method of FIG. 1. For example, in FIG. 2A, screenshot 200 illustrates an exemplary user interface 204 including a presentation of responsorial matter 208 and a visual motivational stimulus 212, as well as an optional answer box 216 (particularly useful when the presentation of responsorial matter includes a presentation of a multiple-choice question and differing possible answers) and an optional obscured image 212A. In this example, as illustrated in screenshot 200 (left), the learning tool may display presentation of responsorial matter 208 over a non-visual-stimulus background. Screenshot 200 illustrates user interface 204 as it may appear to a user after step 105 and prior to step 110 of method 100.

Screenshot 220 (middle) illustrates user interface 204 at the time that a user provides a response at step 110, which the user may accomplish by, for example, selecting one of differing possible answers, such as those illustrated in answer box 216, to a multiple-choice question presented with responsorial matter. In such a case that the presentation of responsorial matter includes a presentation of a multiple-choice question and differing possible answers, presenting the multiple-choice question and differing possible answers may include visually displaying a worded question and worded possible answers, providing an audible indication of a worded question and worded possible answers, and/or displaying a mathematical problem, among others. As illustrated, the only difference between screenshot 220 and screenshot 200 is that an answer corresponding to the user's response in answer box 216 is selected (“checked”) in screenshot 220. In some embodiments, such as those in which no answer box 216 is included with user interface 204, the learning tool may skip directly from screenshot 200 to screenshot 224 (right) after receiving a user response at step 110.

For the purposes of this example, the response provided at step 115 and indicated in answer box 216 of screenshot 220 is treated as correct, and, accordingly, at step 120, the learning tool may control a level of obscurity of visual motivational stimulus 212 by increasing perceptibility of the visual motivational stimulus to produce an unobscured, in-focus visual motivational stimulus 212B, as illustrated in screenshot 224. As also shown in screenshot 224, when a user response is determined to be correct, user interface 204 may cease to display any incorrect answers that may have previously been displayed in answer box 216 while still displaying the correct answer corresponding to the response received from the user. After a predetermined period of time or an appropriate user input, such as selection of a “next” button (not shown) or a verbal (e.g., “next”) or haptic (e.g., shaking or tapping a portion of the learning tool or an accessory connected thereto) command, among others, the learning tool may return to step 105 of method 100 and present a new responsorial matter to the user by producing a display like that shown in screenshot 200 with new presentations of responsorial matter 208, optional answer box 216, and visual motivational stimulus 212.

In some embodiments, after a user provides a correct response, the electronic motivational learning tool may display a visual motivational stimulus for a period of time that increases each time a user submits a correct response and that is reset or reduced upon the user submitting an incorrect response. Alternatively, the motivational learning tool may determine such a period of time as a function of the overall number of correct or incorrect answers a user has submitted or, in some embodiments, may be proportional to the ratio of the number of correct answers to the number of incorrect answers that the user has submitted. In some embodiments, in addition to or instead of increasing the amount of time motivational learning tool presents a visual motivational stimulus to the user, the learning tool may increase and/or decrease the projected desirability of the images as a function of the overall number of correct responses a user has submitted or, in some embodiments, may be proportional to the ratio of the number of correct responses to the number of incorrect responses that the user has provided. For example, if a user continually provides correct responses, the motivational learning tool may present visual motivational stimuli having higher-and-higher projected appeal to the user with each subsequent responsorial matter (e.g., images of subjects increasing in attractiveness as judged by the user). On the other hand, if a user continually provides incorrect responses, the learning tool may present visual motivational stimuli having lower-and-lower projected appeal with each subsequent responsorial matter (e.g., images of subjects decreasing in attractiveness, again as judged by the user). In some embodiments, the learning tool may sequentially overlay a series of responsorial matters, one by one, over or with the same visual motivational stimulus, with each successively correct answer provided by the user resulting in the learning tool presenting a more perceptible version of the image than was previously presented. After the user has provided a predetermined number of correct responses, which may be increased or decreased based on the correctness of responses received from the user, the learning tool may display the visual motivational stimulus clearly and/or with no obstructions or obscurity.

FIG. 2B illustrates an alternative implementation of screenshot 224 of FIG. 2A. After a user provides a response at step 110 of method 100 as indicated in answer box 216 of screenshot 220, which here again is treated as correct for the purposes of this example, the motivational learning tool may produce a display like that shown in screenshot 228 in FIG. 2B rather than that shown in screenshot 224 of FIG. 2A. Particularly, as illustrated in screenshot 228, when a correct answer is received from a user, user interface 204 may cease to display presentation of responsorial matter 208 and answer box 216 and control a level of obscurity of visual motivational stimulus 212 by increasing perceptibility of the visual motivational stimulus to produce a large (compared to the size of the rest of the user interface) unobscured image 212C, which in some cases may also have a higher resolution than obscured image 212A. After a predetermined period of time or an appropriate user input, as discussed above in the context of FIG. 2A, the learning tool may return to step 105 of method 100 and present a new responsorial matter to the user by producing a display like that shown in screenshot 200 of FIG. 2A with new presentations of responsorial matter 208, optional answer box 216, and visual motivational stimulus 212.

While FIGS. 2A-2B illustrate examples of receiving correct responses from a user, FIG. 2C illustrates one example of how the learning tool may react to receiving an incorrect response from a user. In this example, screenshot 232 is the same as screenshot 220 in FIGS. 2A-2B with the exception that an incorrect response, optionally indicated in answer box 216, has been provided by the user at step 110. In this example, after receiving the incorrect response from the user, the learning tool may display a correct answer or clue 212D to the user. The learning tool may present correct answer or clue 212D in such a way that it completely or partially obscures visual motivational stimulus 212, as illustrated in screenshot 236, or it may present the correct answer or clue 212D in such a way that it does not obscure the visual motivational stimulus. In some embodiments, such as but not limited to when only one question is involved and the perceptibility of the visual motivational stimulus is binary, i.e., either obscure or clear, if the user provides an incorrect response, the software may switch visual motivational stimulus 212 to a blank or otherwise not visually stimulating image or background with correct answer or clue 212D overlaid. After a predetermined period of time or an appropriate user input, as discussed above in the context of FIG. 2A, the learning tool may return to step 105 of method 100, present the same responsorial matter presented previously (e.g., the same as that presented in screenshot 232) to the user again by producing a display like that shown in screenshot 200 of FIG. 2A, and permit the user to provide a new response to the responsorial matter with the advantage of having seen correct answer or clue 212D.

In some embodiments, when the learning tool incrementally increases or decreases perceptibility of visual motivational stimulus 212 as a function of the correctness of responses provided by a user, when a user provides a response, the learning tool may implement such incremental changes after the user has viewed correct answer or clue 212D against a blank background and/or subsequently provided another response. Such incremental changes will typically be dependent on the type of obscuring at issue. For example: if the obscuring is based on blurring, such incremental changes may include incremental increases or decreases of blur in visual motivational stimulus 212; if the obscuring is based on scrambled tiling, such incremental changes may include incremental increases or decreases in the scrambling of the tiles corresponding to the visual motivational stimulus; if the obscuring is based on an overlaid textbox, such incremental changes may include incremental increases or decreases in opacity of the textbox, etc.

FIG. 2D illustrates representative screenshots of an exemplary alternative implementation of user interface 204 wherein the motivational learning tool displays at least some of responsorial matter 208 over visual motivational stimulus 212. Screenshots 240, 244, and 248 essentially correspond to screenshots 200, 220, and 224/228 of FIGS. 2A-2B, respectively, with the exception that in FIG. 2D the learning tool presents presentation of responsorial matter 208 and optional answer box 216 as overlays on visual motivational stimulus 212 and optional large obscured image 212E. Similarly, screenshot 248 corresponds essentially to screenshot 228 of FIG. 2B, with the exception that the learning tool may optionally display presentation of responsorial matter 208 and/or a reduced-size answer box 252 (indicating the correct answer corresponding to the response provided by the user) over large unobscured image 212C, though these may be relocated relative to screenshot 244 to render the large unobscured image more visible, as shown in screenshot 248. As described above in connection with screenshots 200, 220, and 224/228 of FIGS. 2A-2B, screenshot 240 illustrates user interface 204 as it may appear to a user after step 105 and prior to step 110 of method 100, screenshot 244 illustrates the user interface at the time that a user provides a response at step 110, and screenshot 248 illustrates the user interface after a user provides a response at step 110 of method 100 as indicated in answer box 216 of screenshot 244, which here, as with FIGS. 2A-2B, is treated as correct for the purposes of this example. After a predetermined period of time or an appropriate user input, as discussed above in the context of FIG. 2A, the learning tool may return to step 105 of method 100 and present a new responsorial matter to the user by producing a display like that shown in screenshot 240 of FIG. 2D with new presentations of responsorial matter 208, optional answer box 216, and visual motivational stimulus 212.

FIG. 2E illustrates representative screenshots of a further exemplary alternative implementation of user interface 204 wherein the learning tool does not display any responsorial matter, though in some embodiments it may present answer box 216 over visual motivational stimulus 212. This implementation can be particularly useful in situations where the learning tool provides responsorial matters and/or possible answers/responses aurally, such as may be the case, for example, when a user is learning words of a foreign language or when the user is utilizing the learning tool in a hands-free mode. In this example, screenshots 256, 260, and 264 correspond essentially to screenshots 240, 244, and 248 of FIG. 2D, respectively, with the exception that no presentation of responsorial matter is displayed.

Further alternative embodiments may not necessarily involve controlling a level of obscurity of a visual motivational stimulus. For example, in one embodiment, when starting a new learning session, the learning tool may overlay a first presentation of responsorial matter onto or display such a first presentation alongside a first otherwise unobscured visual motivational stimulus in a user interface or general display. If the user provides a correct response, the learning tool may overlay a second presentation of responsorial matter onto or display such a second presentation alongside a second otherwise unobscured visual motivational stimulus different from the first. On the other hand, if the user answers the first question incorrectly, the learning tool may display a correct answer or clue, such as correct answer or clue 212D, to the user, optionally overlaying a blank or otherwise not visually stimulating background in place of the first unobscured visual motivational stimulus. After a predetermined period of time or an appropriate user input, as discussed above in the context of FIG. 2A, the learning tool may present the same responsorial matter presented previously to the user again and permit the user to provide a new response to the responsorial matter with the advantage of having seen correct answer or clue. However, because the user has already provided an incorrect response to this responsorial matter, the learning tool may replace the first unobscured visual motivational stimulus in the user interface with a blank or otherwise not visually stimulating background. In this way, the learning tool can ensure that the user will not be able to view any new visual motivational stimulus through the learning tool until they provide a correct response to the responsorial matter to which they previously provided an incorrect response, either right away or after seeing the correct answer or clue. In some alternative embodiments, the user may have to provide more than one incorrect response before the learning tool will cease displaying visual motivational stimulus in this way. In some embodiments, to recover the user may have to input more than one right answer before the learning tool unobscures the visual motivational stimulus.

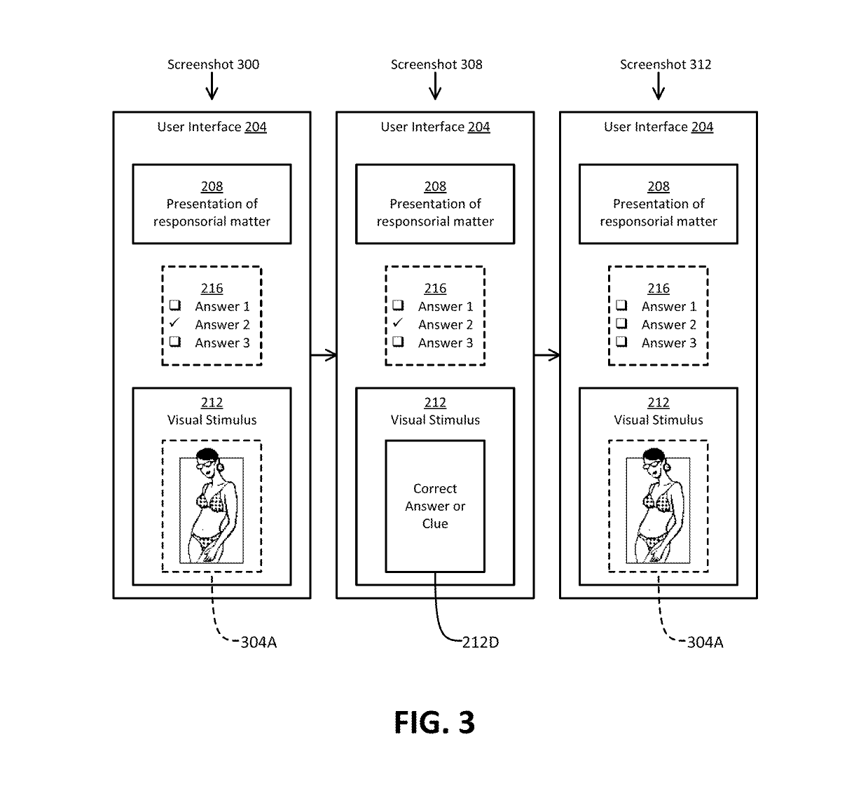

In some embodiments, the blank and/or other backgrounds described as not being visually stimulating in the context of the various embodiments described above may instead be implemented as negatively visually stimulating backgrounds. For example, if a user provides an incorrect response to a responsorial matter, the learning tool may display a correct answer or clue overlaying a background depicting something negative, such as, for example, a crying baby, road kill, or a person that the particular user deems as unappealing or otherwise non-motivating. In some embodiments, in addition to or rather than displaying a correct answer or clue, the learning tool may display a negatively visually stimulating background for a period of time, which may increase each time a user submits an incorrect response and may be reset or reduced upon the user submitting a correct response. Alternatively, the learning tool may determine such a period of time as a function of the overall number of incorrect responses a user has submitted and/or change the period of time proportionally to the ratio of the number of correct responses to the number of incorrect responses that the user has submitted. In some embodiments, in addition to or instead of increasing the amount of time a negative stimulus is presented to the user, the learning tool may increase or decrease a projected desirability of the images as a function of the overall number of correct or incorrect responses a user has submitted and/or change the projected desirability proportionally to the ratio of the number of correct responses to the number of incorrect responses that the user has submitted . For example, as a user continues to provide incorrect responses, an image of a cute squirrel may take on an appearance more-and-more like road-kill and less-and-less like a squirrel as the user continues to provide incorrect responses, each of which may be displayed for a longer period of time based on, for example, a ratio of correct to incorrect answers or a total number of incorrect answers.

Whereas embodiments described above in connection with FIGS. 2A-2E involve the motivational learning tool at issue presenting obscured and de-obscured versions of visual motivational stimuli, other embodiments such as those described above may be implemented with only clear, i.e., unobscured motivational stimuli. For example, FIG. 3 illustrates one way the learning tool may react to receiving an incorrect response from a user in such alternative embodiments. In this example, screenshot 300 is essentially the same as screenshot 232 in FIG. 2C with the exception that optional obscured image 212A is replaced by optional unobscured image 304A. In this example, after receiving the incorrect response from the user, the learning tool may display a correct answer or clue 212D to the user. The learning tool may present correct answer or clue 212D over a blank or otherwise not visually stimulating background, in such a way that it completely or partially obscures visual motivational stimulus 212, as illustrated in screenshot 308, or in such a way that it does not obscure the visual motivational stimulus. After a predetermined period of time or an appropriate user input, as discussed above in the context of FIG. 2A, the learning tool may display an interface like that shown in screenshot 312, which is essentially the same as screenshot 200 in FIG. 2C with the exception that optional obscured image 212A is replaced by optional unobscured image 304A, present the same responsorial matter presented previously (e.g., the same as that presented in screenshot 300), and permit the user to provide a new response to the responsorial matter with the advantage of having seen correct answer or clue 212D.

Though not explicitly illustrated in FIG. 3, when the user provides a correct response to the responsorial matter, the learning tool may display an indication thereof (e.g., a screen displaying the word “correct”) and then, either after a predetermined period of time or an appropriate user input, as discussed above in the context of FIG. 2A, the tool may present a new responsorial matter to the user along with a new unobscured visual motivational stimulus. This functionality can help to retain user interest, as users may have to provide a correct response before the learning tool will display a new visual stimulus. After reading this disclosure in its entirety, numerous alternative embodiments will become readily apparent to those of ordinary skill in the art. For example, though the use of unobscured motivational stimuli has been described in connection with FIG. 3 as an alternative to the example of FIG. 2C, an unobscured motivational stimulus may be used instead of an obscured motivational stimulus as an alternative to each of the examples of FIGS. 2A-2B and 2D-2E. In one example, a large unobscured image may be used in place of optional large obscured image 212E of FIGS. 2D-2E. Generally, such alternative embodiments may utilize an alternative method of motivating a user to partake in an activity, the method being executed automatedly in an electronic motivational learning tool and comprising: presenting first responsorial matter to a user along with a first visual stimulus, receiving from the user a response to the responsorial matter, determining a correctness of the response, and, if the correctness is right, presenting second responsorial matter different from the first to the user along with second visual stimulus different from the first. If the correctness is wrong, the method may continue to provide the first responsorial matter and first visual stimulus to the user, perhaps interspersed with correct answer or clue screens, and only display a second responsorial matter and second visual stimulus to the user after they provide a correct response to the first responsorial matter.

In addition, in some embodiments, such as any of the embodiments explicitly described above, the learning-tool software may be designed and configured to increase the difficulty of the responsorial matter with increasing numbers of successively correct responses. As those skilled in the art will readily appreciate, there are various objective measures for judging difficulty of responsorial matter, such as by using a control group of individuals having characteristics of the target audience for any particular instantiation of the learning-tool software, presenting a set of responsorial matter to the individuals, and collecting response-correctness data for the group. The lower the percentage of correctness across the control group, the higher the difficulty. Of course, there are other ways known in the art for judging difficulty of responsorial matter, such as collecting response-correctness data from previously administered standardized tests. Further, as the responsorial matter becomes more difficult, the learning-tool software may present visual stimuli that increases in appeal to the user. Conversely, some embodiments of the learning-tool software may decrease the difficulty of the responsorial matter and/or decrease the appeal of the visual stimulus with incorrect responses.

It is to be noted that any one or more of the aspects and embodiments described herein may be conveniently implemented using one or more machines (e.g., one or more computing devices that are utilized as a user computing device for learning, one or more server devices, such as an educational application server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a wearable computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 4 shows a diagrammatic representation of one embodiment of a computing device in the exemplary form of a computer system 400 within which a set of instructions for causing a control system to perform any one or more of the aspects and/or methodologies of the present disclosure, such as method 100, may be executed. It is also contemplated that multiple computing devices may be utilized to implement a specially configured set of instructions for causing one or more of the devices to perform any one or more of the aspects and/or methodologies of the present disclosure. Computer system 400 includes a processor 404 and a memory 408 that communicate with each other, and with other components, via a bus 412. Bus 412 may include any of several types of bus structures including, but not limited to, a memory bus, a memory controller, a peripheral bus, a local bus, and any combinations thereof, using any of a variety of bus architectures.

Memory 408 may include various components (e.g., machine readable media) including, but not limited to, a random access memory component, a read only component, and any combinations thereof. In one example, a basic input/output system 416 (BIOS), including basic routines that help to transfer information between elements within computer system 400, such as during start-up, may be stored in memory 408. Memory 408 may also include (e.g., stored on one or more machine-readable media) instructions (e.g., software) 420 embodying any one or more of the aspects and/or methodologies of the present disclosure. In another example, memory 408 may further include any number of program modules including, but not limited to, an operating system, one or more application programs, other program modules, program data, and any combinations thereof.

Computer system 400 may also include a storage device 424. Examples of a storage device (e.g., storage device 424) include, but are not limited to, a hard disk drive, a magnetic disk drive, an optical disc drive in combination with an optical medium, a solid-state memory device, and any combinations thereof. Storage device 424 may be connected to bus 412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 424 (or one or more components thereof) may be removably interfaced with computer system 400 (e.g., via an external port connector (not shown)). Particularly, storage device 424 and an associated machine-readable medium 428 may provide nonvolatile and/or volatile storage of machine-readable instructions, data structures, program modules, and/or other data for computer system 400. In one example, software 420 may reside, completely or partially, within machine-readable medium 428. In another example, software 420 may reside, completely or partially, within processor 404.

Computer system 400 may also include an input device 432. In one example, a user of computer system 400 may enter commands and/or other information into computer system 400 via input device 432. Examples of an input device 432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 432 may be interfaced to bus 412 via any of a variety of interfaces (not shown) including, but not limited to, a serial interface, a parallel interface, a game port, a USB interface, a FIREWIRE interface, a direct interface to bus 412, and any combinations thereof. Input device 432 may include a touch screen interface that may be a part of or separate from display 436, discussed further below. Input device 432 may be utilized as a user selection device for selecting one or more graphical representations in a graphical interface as described above.

A user may also input commands and/or other information to computer system 400 via storage device 424 (e.g., a removable disk drive, a flash drive, etc.) and/or network interface device 440. A network interface device, such as network interface device 440, may be utilized for connecting computer system 400 to one or more of a variety of networks, such as network 444, and one or more remote devices 448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 444, may employ a wired and/or a wireless mode of communication. In general, any network topology may be used. Information (e.g., data, software 420, etc.) may be communicated to and/or from computer system 400 via network interface device 440.

Computer system 400 may further include a video display adapter 452 for communicating a displayable image to a display device, such as display device 436. Examples of a display device include, but are not limited to, a liquid crystal display (LCD), a cathode ray tube (CRT), a plasma display, a light emitting diode (LED) display, and any combinations thereof. Display adapter 452 and display device 436 may be utilized in combination with processor 404 to provide graphical representations of aspects of the present disclosure. In addition to a display device, computer system 400 may include one or more other peripheral output devices including, but not limited to, an audio speaker, a printer, and any combinations thereof. Such peripheral output devices may be connected to bus 412 via a peripheral interface 456. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1-60. (canceled)

61. A user interface for motivating a user to partake in an activity, said user interface being displayed by an electronic motivational learning tool and comprising:
a first component configured for presenting to the user responsorial matter;
a second component configured for presenting to the user a visual motivational stimulus; and
a third component configured for receiving from the user a response to said responsorial matter;
wherein said electronic motivational learning tool determines a correctness of said response and controls a level of obscurity of said visual motivational stimulus presented by said second component as a function of said correctness of said response.

62. A user interface according to claim 61, wherein:
said electronic motivational learning tool displays at least some of said responsorial matter over said visual motivational stimulus; and
said electronic motivational learning tool controls a level of obscurity of said visual motivational stimulus by increasing perceptibility of said visual motivational stimulus only when said correctness is right.

63. A user interface according to claim 62, wherein said increasing perceptibility of said visual motivational stimulus produces a completely unobscured visual motivational stimulus.

64. A user interface according to claim 62, wherein said increasing perceptibility of said visual motivational stimulus produces a partially unobscured visual motivational stimulus.

65. A user interface according to claim 61, wherein:
said presenting responsorial matter includes displaying at least some of said responsorial matter over a non-visual-stimulus background; and
said controlling a level of obscurity of said visual motivational stimulus includes displaying an in-focus visual motivational stimulus image only when said correctness is right.

66. A user interface according to claim 61, wherein said controlling a level of obscurity of said visual motivational stimulus includes decreasing perceptibility of said visual motivational stimulus when said correctness is wrong.

67. A user interface according to claim 61, wherein:
said electronic motivational learning tool displays to the user a clue via at least one of said components of said user interface when said correctness is wrong; and
said electronic motivational learning tool permits the user to provide a new response to said responsorial matter via said third component of said user interface.

68. A user interface according to claim 67, wherein said controlling a level of obscurity of said visual motivational stimulus includes decreasing perceptibility of said visual motivational stimulus.

69. A user interface according to claim 61, wherein:
said presenting responsorial matter includes presenting a multiple-choice question and differing possible answers; and
said receiving a response includes receiving a user selection of one of said differing possible answers.

70. A user interface according to claim 69, wherein said presenting a multiple-choice question and differing possible answers includes visually displaying a worded question and worded possible answers.

71. A user interface according to claim 69, wherein said presenting a multiple-choice question and differing possible answers includes providing an audible indication of a worded question and worded possible answers.

72. A user interface according to claim 69, wherein said presenting a multiple-choice question includes displaying a mathematical problem.

73. A user interface according to claim 61, wherein:
said presenting responsorial matter includes displaying a mathematical problem; and
said receiving a response includes receiving a numerical answer input by the user.

74. A user interface according to claim 61, wherein controlling a level of obscurity of said visual motivational stimulus comprises controlling a level of blur, brightness, color, sharpness, or contrast of said visual motivational stimulus.

75. A user interface according to claim 61, wherein controlling a level of obscurity of said visual motivational stimulus comprises controlling a level of zoom or overall size of said visual motivational stimulus.

76. A user interface according to claim 61, wherein said electronic motivational learning tool selects said visual motivational stimulus by interfacing with one or more external systems containing information regarding or provided by the user.

77. A user interface according to claim 76, wherein said one or more external systems include one or more social networking services.

78. A user interface for motivating a user to partake in an activity, said user interface for being displayed by an electronic motivational learning tool and comprising:
a first component configured for presenting to the user first responsorial matter;
a second component configured for presenting to the user a first visual motivational stimulus; and
a third component configured for receiving from the user a first response to said first responsorial matter;
wherein:
said electronic motivational learning tool determines a first correctness of said first response; and
if said first correctness is right, said electronic motivational learning tool presents to the user, via said user interface:
second responsorial matter different from said first responsorial matter via said first component; and
a second visual motivational stimulus different from said first via said second component.

79. A user interface according to claim 78, wherein, if said first correctness is wrong, said electronic motivational learning tool presents to the user, via at least one component of said user interface, a correct answer to said first responsorial matter.

80. A user interface according to claim 79, wherein, following said presenting a correct answer, said electronic motivational tool presents, via said user interface:
said second responsorial matter via said first component; and
said second visual motivational stimulus via said second component.

81. A user interface according to claim 78, wherein, if said first correctness is wrong, said electronic motivational learning tool presents to the user a clue to assist the user in answering said responsorial matter.

82. A user interface according to claim 81, wherein, following said presenting a clue, said electronic motivational learning tool re-presents, via said user interface:
said first responsorial matter via said first component; and
said first visual motivational stimulus via said second component.

83. A user interface according to claim 82, wherein, following said re-presenting, said electronic motivational learning tool:
receives from the user a second response to said first responsorial matter via said third component of said user interface;
determines a second correctness of said second response; and
if said first correctness is right, presents to the user, via said user interface:
said second responsorial matter via said first component; and
said second visual motivational stimulus via said second component.

84. A user interface according to claim 78, wherein:
said presenting first responsorial matter includes presenting a multiple-choice question and differing possible answers; and
said receiving a first response includes receiving a user selection of one of said differing possible answers.

85. A user interface according to claim 84, wherein said presenting a multiple-choice question and differing possible answers includes visually displaying a worded question and worded possible answers.

86. A user interface according to claim 84, wherein said presenting a multiple-choice question and differing possible answers includes providing an audible indication of a worded question and worded possible answers.

87. A user interface according to claim 84, wherein said presenting a multiple-choice question includes displaying a mathematical problem.

88. A user interface according to claim 78, wherein:
said presenting first responsorial matter includes displaying a mathematical problem; and
said receiving a response includes receiving a numerical answer input by the user.

89. A user interface according to claim 78, wherein said electronic motivational learning tool selects said first visual motivational stimulus by interfacing with one or more external systems containing information regarding or provided by the user.

90. A user interface according to claim 89, wherein said one or more external systems include one or more social networking services.
